(19) United States
(12) Patent Application Publication
(10) Pub. No.: US 2005/0198351 A1
(43) Pub. Date: Sep. 8, 2005

(54) Content-based routing

(75) Inventors: Saurab Nog, Sammamish, WA (US); Alfred Lee IV, Seattle, WA (US); David Levin, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/784,146

(22) Filed: Feb. 20, 2004

(51) Int. Cl. G06F 15/16

(52) U.S. Cl. 709/232; 709/238

(57) ABSTRACT

Implementations are described and claimed herein for content-based routing of messages in an overlay network. According to an exemplary implementation, routing nodes receive messages and return routing policies to the sending node based at least in part on content of the message. The routing policies include instructions for redirecting similar messages to other nodes in the overlay network. The sending node determines which policies to apply to the message. The sending node may then iterate through the routing policies, modifying the address in the message according to instructions included in the routing policies so that the message is sent, e.g., directly to the intended destination. Accordingly, the sending node is able to bypass one or more intermediary nodes to reduce latency in the overlay network.

### TECHNICAL FIELD

The described subject matter relates to electronic computing, and more particularly to systems and methods of content-based routing in electronic computing networks.

### BACKGROUND

In large networks such as the Internet, data packets are routed to a destination by routers. These routers send and receive messages but do not otherwise process the message. The routers typically do not even maintain any information about the data packet much less communicate other information about the data packet to other routers or to the sender.

Overlay networks may be provided on the existing network infrastructure to process data packets at the application level, and therefore are able to provide additional routing services (e.g., security). Overlay networks are implemented by overlay nodes linked to one another by overlay links. Each overlay link may include many physical links in the underlying network infrastructure.

Overlay nodes process every data packet at the application level before resending the data packet to the next node in the overlay network. In addition, overlay nodes may not be optimally positioned because there is often little or no knowledge of the physical layout of the underlying network infrastructure. These factors contribute to longer latency in the overlay network. In addition, overlay routers may become a central point of failure. For example, if particular types of messages have to be routed by a single overlay router and that router fails, the messages do not reach their intended destination.

### SUMMARY

Implementations are described and claimed herein for content-based routing in an overlay network. According to an exemplary implementation, data packets are received by routing nodes in an overlay network. In addition to forwarding the message to another routing node or to the destination node, the routing nodes also return routing policies to the sending node.

The routing policies include instructions for redirecting messages based on content of the message. For example, when a message is received by a first routing node and redirected to a second routing node, the first routing node may also return a routing policy to the sending node. The routing policy instructs the sending node to bypass the first routing node and issue other messages with similar content directly to the second routing node.

Before issuing a message, the sending node determines which policies apply to the message, and may also apply other policies (e.g., security policies) to the message. The sending node iterates through the routing policies, modifying the address in the message according to the instructions included in applicable routing policies. For example, the message may be modified based on a routing policy so that instead of sending the message to a first routing node, the message is sent to a second routing node. The message may be modified again based on another routing policy so that instead of sending the message to the second routing node, the message is sent directly to a destination node. The sending node is able to bypass one or more intermediary nodes (or routing nodes), reducing latency in the overlay network and reducing or eliminating the occurrence of central failures. In addition, the sending node is able to automatically discover and refine shortcuts in the overlay network.

In some implementations, articles of manufacture are provided as computer program products. One implementation of a computer program product provides a computer program storage medium readable by a computer system and encoding a computer program for content-based routing. Another implementation of a computer program product may be provided in a computer data signal embodied in a carrier wave by a computing system and encoding the computer program for content-based routing.

The computer program product encodes a computer program for executing a computer process on a computer system that includes receiving a message at a routing node in an overlay network, and generating a routing policy for a sending node based at least in part on the message content.

In another implementation of the computer program product, a computer process includes identifying at least one routing policy for a message based on the message content, and changing an address in the message to bypass at least one node in an overlay network based on the at least one routing policy.

In yet another implementation, a method is provided. The method includes receiving a message at a routing node in an overlay network, and generating a routing policy for a sending node based at least in part on the message content.

In another implementation, a method includes identifying at least one routing policy for a message based on the message content, and changing an address in the message to bypass at least one node in an overlay network based on the at least one routing policy.

In yet another implementation, a system is provided including a routing node receiving a message in an overlay network. A message processor is provided at the routing node. The message processor generates a routing policy for a sending node of the message based at least in part on the message content.

In another implementation of the system a messaging module at the sending node changes an address in a message to bypass at least one node in an overlay network based on at least one routing policy.

### BRIEF DESCRIPTION OF THE DRAWINGS

FIG. 1 is a schematic illustration of an exemplary computer network that may implement content-based routing;

FIG. 2 is a schematic diagram of exemplary nodes in an overlay network that may implement content-based routing;

FIG. 3 is a high-level diagram illustrating an exemplary implementation of content-based routing in an overlay network;

FIG. 4 is another high-level diagram illustrating an exemplary implementation of content-based routing in an overlay network;

FIGS. 5-6 are flowcharts illustrating exemplary operations to implement content-based routing; and

FIG. 7 is a schematic illustration of an exemplary computing device that can be utilized to implement content-based routing.

### DETAILED DESCRIPTION

Briefly, routing nodes may be implemented in an overlay network to return routing policies to a sending node. The routing policies include instructions to bypass one or more intermediary nodes in the overlay network. The sending node may apply these routing policies to data packets (or messages) to reduce latency in the overlay network.

For purposes of illustration, a user attempting to purchase a book from a commercial web service (e.g., msn.com) may issue a message for the commercial web service which is received by a routing node in the overlay network. The routing node resends the message, e.g., to a destination node in the bookstore division at the commercial web service. In addition to forwarding the message, the routing node also returns a routing policy to the sending node.

The routing policy includes instructions for sending similar messages. In this example, an overlay router or routing node may return a routing policy that instructs the sending node to issue book purchasing messages directly to the node for the bookstore division at the commercial web service.

The sending node maintains these routing policies (e.g., along with other policies) to apply to new messages. Before sending a new message, the sending node iterates through the routing policies, modifying the address in the message according to applicable routing policies. In this example, the message may be modified based on the routing policy so that the message is sent directly to the destination node and bypasses one or more intermediary or routing nodes in the overlay network.

Exemplary System

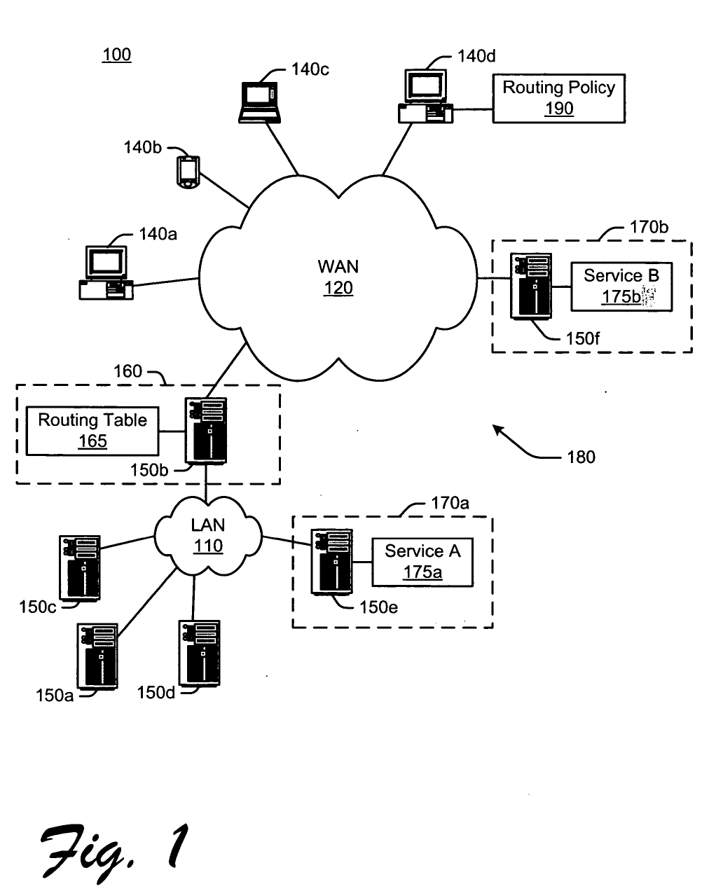

FIG. 1 is a schematic illustration of an exemplary computer network that may implement content-based routing. The networked computer system 100 may include one or more communication networks, such as local area network (LAN) 110 and/or wide area network (WAN) 120. One or more sending devices 140a-d may be linked to one or more destination nodes 150a-f over the communication network(s) 110, 120.

Sending devices 140a-d and destination nodes 150a-f connect to a network via a communication connection such as, e.g., an Ethernet connection. Although there are no theoretical limits on the number of computing devices that can be included in a network such as network 100, the number of computing devices are limited primarily by the connectivity implemented in the network.

The term “node” is used herein to refer to sending nodes, routing nodes, and destination nodes and includes the hardware and software (i.e., the entire computer system) used to perform various computing operations. For purposes of illustration, a sending node may be implemented, e.g., as a stand-alone personal desktop or laptop computer (PC), workstation, personal digital assistant (PDA), or electronic appliances, to name only a few examples. A destination node may be implemented, e.g., as a server computer that is dedicated to server applications or that also runs other applications. Other implementations are also contemplated and are not limited to the examples described above.

It is noted that a destination node may be operatively associated with one or more resources. Resources available via the destination node may include other computing or data processing systems, storage, or other devices. The destination node may also provide the sending node with services, such as transaction processing, interactive web pages, email, etc.

An overlay network 180 may be implemented, e.g., on the network infrastructure shown in FIG. 1. Overlay network 180 includes overlay nodes, such as, e.g., routing node 160 and destination nodes 170a, 170b. Overlay nodes may be implemented as server computers or other computing devices. In FIG. 1 for example, routing node 160 is implemented at server computer 150b and destination nodes 170a, 170b are implemented at server computers 150e, 150f which provide access to services 175a, 175b (e.g., web applications).

Messages are transmitted between overlay nodes via one or more overlay links (not shown). Overlay links may include many physical links (e.g., router devices and server computers) in the underlying network(s) 110, 120. Routing node(s) 160 receive and reissue messages in the overlay network 180 based on routing table(s) 165.

Routing node(s) 160 process messages in the overlay network 180 at the application level and may be implemented to return one or more routing policies 190 to, e.g., one or more of the sending nodes. The routing policies 190 include instructions that the sending node may apply to similar messages to bypass one or more of the routing nodes 160, as will be discussed in more detail below.

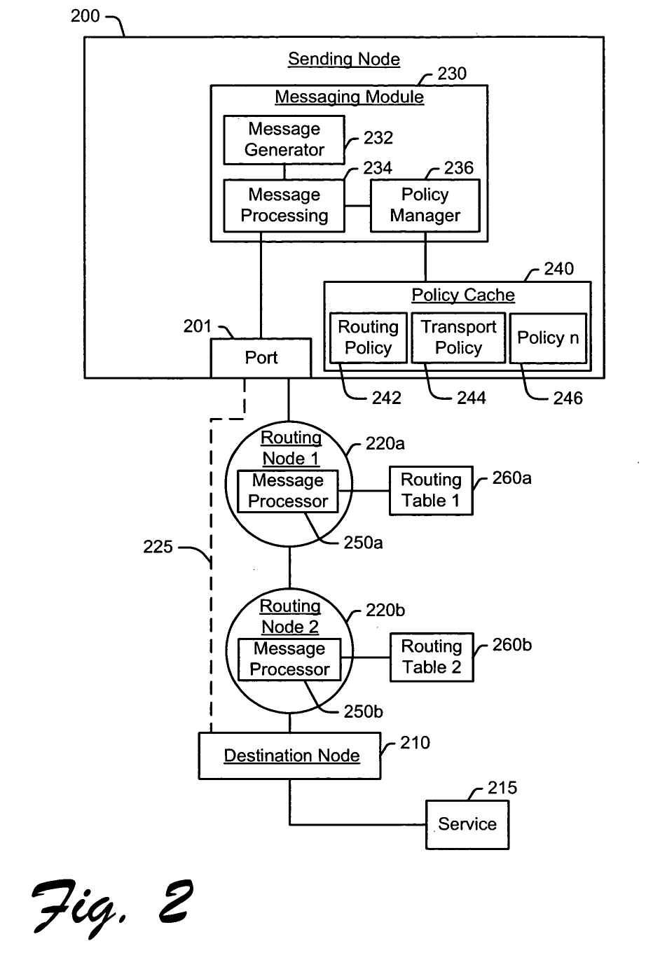

FIG. 2 is a schematic diagram of exemplary nodes that may implement content-based routing in an overlay network. Sending node 200 may connect to a destination node 210 via an overlay network. In FIG. 2, sending node 200 connects to the destination node 210 via port 201 and data packets (or messages) issued by the sending node 200 may be delivered to the destination node 210 via one or more routing nodes 220a, 220b. Alternatively, messages may bypass routing nodes 220a, 220b and may be delivered directly to destination node 210, as illustrated by dashed line 225 and discussed in more detail below.

Referring to FIG. 2, sending node 200 may include a messaging module 230 operatively associated with a policy cache 240. Messaging module 230 may be implemented in computer-readable program code (e.g., software and/or firmware) stored in computer-readable storage or memory and executable by a processor (or processing units) at the sending node 200. Messaging module 230 may include a message generator 232, message processing module 234, and policy manager 236.

Message generator 232 may be implemented to generate data packets (or messages) to communicate with the destination node 210. For example, a message may include a request to access a service (e.g., a web application or remote database) via the destination node 210. Of course messages are not limited to such requests and may also include, by way of example, credit card information, security credentials, and data for remote storage, to name only a few such examples.

Message processing module 234 may be implemented to prepare messages to be issued in an overlay network. For example, the message processing module 234 may cooperate with policy manager 236 to apply one or more policies to the message before it is issued.

Policy manager 236 is operatively associated with policy cache 240. Policy cache 240 may be stored in memory. Policy cache 240 may include one or more policies, such as, e.g., routing policy 242, transport policy 244, and any number of other types of policies 246 (e.g., a security policy).

In an exemplary implementation, the Web Services Policy (WS-Policy) specification defines a general model and syntax for policy expressions. The policy may be expressed in machine-readable extensible markup language (XML) format to facilitate interoperability between different platforms and web services infrastructure. Of course a policy is not limited to any particular syntax or format and other implementations are also possible.

Routing policies 242 may be received at the sending node 200 from one or more routing nodes 220a, 220b, e.g., in response to issuing messages as discussed in more detail below. Routing policies 242 identify direct paths to other nodes that bypass one or more routing nodes 220a, 220b in the overlay network.

Transport policies 244 identify the preferred, or in some cases, the required transport protocol to communicate with a node in the overlay network. For purposes of illustration, the transport protocol may be Simple Object Access Protocol (SOAP). SOAP is a messaging protocol used to encode transactions for transfer over a network using any of a variety of Internet protocols (e.g., HTTP, SMTP, MIME). SOAP messages do not need to be formatted for use with any particular operating system, making SOAP messages commonplace in network environments. However, other transport protocols are also contemplated and may include, e.g., HTTP, SMTP and other protocols now known or that may be later developed.

In an exemplary implementation, policies are applied to messages in the following order: 1) security policies, 2) routing policies, 3) transport policies, and 4) general policies such as, e.g., compression and encryption policies. Transport policies are applied after the routing policies because the transport protocol may depend at least to some extent on the message address, and may change as the routing policies are applied to the message. It is noted, however, that in other implementations the policies do not have to be applied in any particular order.

It is noted that the sending node 200 is not limited to the exemplary implementation shown in FIG. 2. For example, the functions do not need to be embodied in separate modules. In yet other implementations, additional functional components may also be included.

Continuing our discussion with reference to FIG. 2, routing nodes 220a, 220b (hereinafter generally referred to as reference nodes 220) may be implemented in the overlay network to receive messages, process messages, and resend the messages to another node in the overlay network (e.g., to another routing node or a destination node). Routing nodes 220 pass the message to the application level for processing (e.g., at message processor 250a, 250b). Message processor 250a, 250b may be implemented as computer-readable program code (e.g., software and/or firmware) stored in computer-readable storage or memory and executable by a processor (or processing units) at the routing node 220.

Message processors 250 are operatively associated with routing tables 260a, 260b (hereinafter generally referred to as routing tables 260). Routing tables 260 identify one or more paths to route messages in the overlay network. Routing tables 260 may identify other routing nodes or a destination node based on, e.g., the type of message or message content. Message processors 250 use the routing tables 260 to determine an address to reroute a message in the overlay network.

For purposes of illustration, a message including a request to purchase a book may be issued to a routing node that processes book purchasing requests. The routing node may process the message and determine that the request is for a fiction novel. The message is then reissued to a destination node that processes requests for fiction novels. Alternatively, if the routing node determines that the request is for a technical textbook, the request is routed to a destination node that processes requests for technical textbooks.

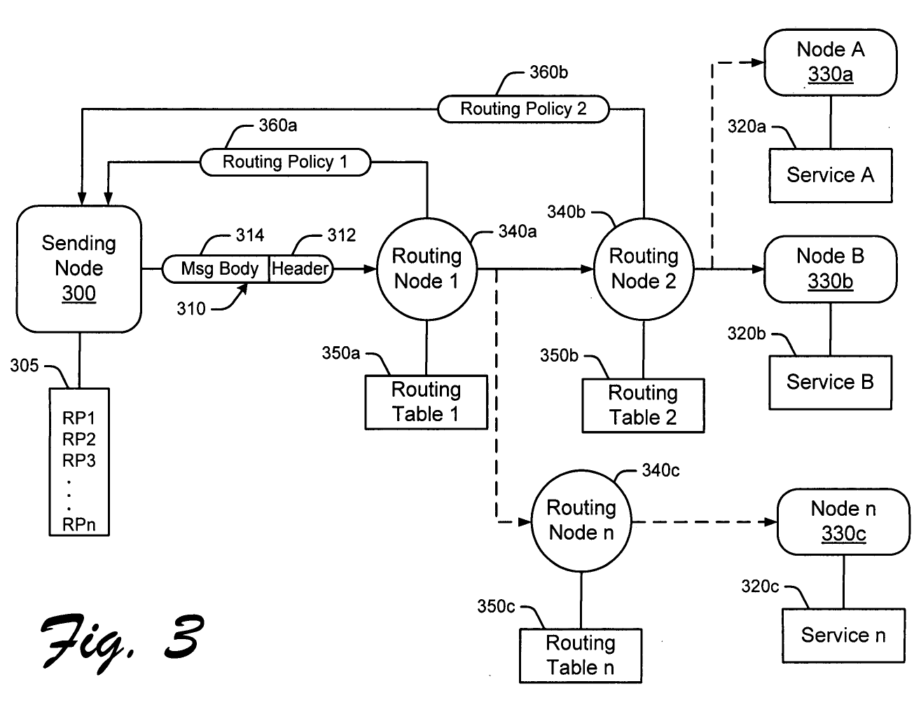

FIG. 3 is a high-level diagram illustrating an exemplary implementation of content-based routing in an overlay network. In this illustration, sending node 300 generates and issues message 310 including a request to purchase a book from a book selling service (e.g., Service A) at a commercial web site (e.g., one of the destination nodes 330a).

Message 310 may include a header 312 identifying an address for the message 310, and a body 314, e.g., containing a request to purchase the book. In an exemplary implementation, the address is identified in the header 312 of a SOAP message 310 using XPath expressions.

XPath provides common syntax and semantics for XSL Transformations (XSLT) and XPointer. XPath uses path notation to navigate the XML document hierarchy and operates on the logical structure of an XML document instead of its surface syntax, allowing manipulation of strings, numbers and Boolean expressions in XML documents. However, implementations are not limited to XPath expressions.

Although the sending node 300 may not have an address for the destination node, the sending node 300 may have an address for a neighboring node (e.g., routing node 340a) that can process and reroute the message 310. Accordingly, sending node 300 issues message 310 to routing node 340a. The message 310 is passed to the application level (e.g., message processor 250 in FIG. 2) for processing at the routing node 340a. Processing may include determining a type of message based on the message content. The message content may include information included in header 302 and/or message body 304. Routing node 340a accesses a routing table 350a to determine an address to route the message 310 to based at least in part on the message content. An exemplary routing table that may be implemented at routing node 340a is illustrated in Table 1.

TABLE 1
Exemplary Routing Table 1

| Message Type | Address |
|---|---|
| Purchase Book | Routing Node 2 |
| Open Account | Routing Node n |

Exemplary Routing Table 1 illustrated above by Table 1 includes categories or types of messages and a corresponding address for the message and may be used to identify another address for the message 310 based on the message content. As an illustration, if message 310 includes a request to purchase a book, the message address is modified to “Routing Node 2”, e.g., by modifying message header 302 at the application level at routing node 340a. Alternatively, if the message 310 includes a request to open a new account, the address is modified to “Routing Node n.”

After modifying the address in message 310, the message is passed to the messaging level where it is reissued by routing node 340a in the overlay network, e.g., to routing node 340b (Routing Node 2) or routing node 340c (Routing Node n).

When the message 310 is received by the next routing node (e.g., routing node 340b), the message 310 is again passed to the application level to determine the message content and another address for the message, e.g., based on routing table 350b. An exemplary routing table 350b that may be implemented at routing node 340b is illustrated in Table 2.

TABLE 2
Exemplary Routing Table 2

| Message Type | Address |
|---|---|
| Purchase Request | |
| *Fiction | Destination Node A |
| *Textbook | Destination Node B |

Again, exemplary Routing Table 2 illustrated above in Table 2 includes categories or types of messages and a corresponding address which may be used to identify the next node for message 310 based on the message content. As an illustration, if message 310 includes a request to purchase a fiction novel, the address of the message is modified to “Destination Node A”, e.g., by modifying the message header 302 at the application level at routing node 340b. Alternatively, if the message 310 includes a request to purchase a textbook, the address of the message is modified to “Destination Node B.”

In addition to processing and reissuing message 310, one or more of the routing nodes 340a, 340b may also return a routing policy 360a, 360b to the sending node 300. As discussed above, routing policies include instructions for routing messages based on the message content to bypass one or more of the routing nodes in an overlay network. Routing policies 360a, 360b are maintained by the sending node 300, e.g., in cache 305.

It is noted that more routing policies received by a sending node tend to refine the granularity of content-based routing in the overlay network. For example, if a single routing node returns a routing policy to the sending node, new messages may be issued by the sending node based on the routing policy to bypass the single routing node. However, if multiple routing nodes return a plurality of routing policies, new messages may be issued by the sending node based on these routing policies to bypass a plurality of routing nodes. For example, if only routing policy 360a is received, the sending node can shortcut Routing Node 2. But if both routing policies 360a, 360b are received, the sender can bypass both intermediate nodes and be issued directly to the destination node. In addition, sending messages to a plurality of destination nodes tends to increase the number of routing policies that are received by the sending node, increasing the number of routing policies that the sending node has available for different types of messages.

Still other implementations are also contemplated. For example, although the routing policies have been illustrated as being returned to the sending node in FIG. 3, the routing policies may be returned to other nodes in the overlay network (e.g., one or more of the routing nodes). These other nodes may then apply the routing policies to messages to bypass other intermediary nodes in the overlay network. For example, if routing nodes 340a, 340b exchanged a routing policy regularly, then the first message issued by the sender might result in routing node 340a returning both routing policies 360a, 360b and also allow routing node 340a to send a message directly to the destination node.

In another exemplary implementation, the routing nodes may process the message to include a routing policy within the message 310 itself (e.g., as part of the message header 312 or message body 314). When the message 310 reaches an endpoint (e.g., a destination node 320), the node extracts the routing policies from the message 310 and returns one or more of the routing policies to the sending node.

In yet another exemplary implementation, the routing policies do not need to be returned to the sending node if the sending node has already received a routing policy. In still another exemplary implementation, the routing policies may be combined into a master routing policy.

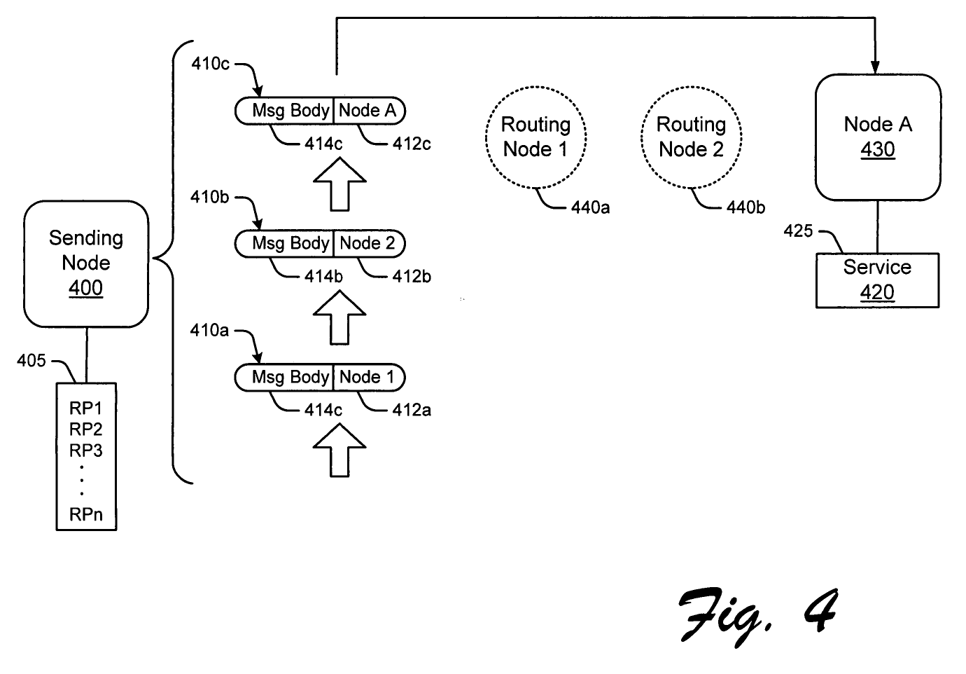

FIG. 4 is another high-level diagram illustrating an exemplary implementation of content-based routing in an overlay network. In this illustration, a sending node 400 issues a message including a request to purchase a book from a book selling service 420 at destination node 430 (e.g., a commercial website).

The sending node 400 generates a message 410a which may include a header 402a including a node address, and a body 404, e.g., having the book 2 purchase request. Before issuing the message 410a, sending node 400 determines if one or more routing policies (e.g., maintained in cache 405) apply to the message 410a.

In an exemplary implementation, routing policies were already received from routing nodes 440a, 440b in response to sending similar messages, as described above with reference to FIG. 3. The sending node 400 may access one or more of these routing policies from cache 405 and determine whether one or more of the routing policies apply to the message 410a.

Exemplary routing policies are illustrated in Tables 3 and 4.

TABLE 3
Exemplary Routing Policy 1

| Condition | Instruction |
|---|---|
| IF | THEN |
| Operation = Purchase Book | Change Address to Routing |
| AND | Node 2 |
| Address = Routing Node 1 | |

TABLE 4
Exemplary Routing Policy 2

| Condition | Instruction |
|---|---|
| IF | THEN |
| BookID = Fiction Novel | Change Address to Destination |
| AND | node A |
| Address = Routing Node 2 | |

The exemplary routing policies illustrated above in Tables 3 and 4 include one or more conditions and corresponding instruction(s) to be implemented if the condition(s) are satisfied. XPath expressions may be used in an exemplary implementation to define the conditions. XPath expressions may be readily tested to determine if a message matches a pattern (e.g., if the message content is similar to message content identified by a routing policy). Other implementations are also contemplated, however, and are not limited to XPath expressions. In any event, the routing policies may be used by the sending node to modify the message address.

In operation, the sending node 400 may iterate through the routing 8 policies and apply routing policies based on the message content. For purposes of illustration, if the message 410 contains a request to purchase a book and the address is “Routing Node 1,” then the address of the message 410a may be modified to “Routing Node 2” based on the routing policy illustrated in Table 3. Furthermore, if the modified message 410b contains a request to purchase a fiction novel and the address is “Routing Node 2,” then the address of the message 410b is again modified, this time from “Routing Node 2” to “Destination Node A” based on the routing policy illustrated in Table 4.

In an exemplary implementation, the routing policies are applied to the message 410a and then to the modified message 410b in an ordered manner. That is, the routing policy identifying the first routing node is applied before the routing policy identifying the second routing node so that each of the conditions are satisfied and each of the routing policies is properly applied. However, applying the routing policies to a message is not limited to any particular order.

After iterating through the routing policies, sending node 400 may issue the modified message 410c in the overlay network. The modified message 410c is sent directly to Destination Node A (node 430), bypassing routing nodes 440a, 440b.

It is noted that although message 410c is illustrated in FIG. 4 as bypassing each intermediary node 440a and 440b, messages do not need to always be modified for direct routing to a destination node. For example, a message may be issued by the sending node directly to “Routing Node 2,” only bypassing “Routing Node 1” in the example illustrated in FIG. 4.

Exemplary Operations

Described herein are exemplary methods for implementing content-based routing in a network environment, such as the exemplary overlay networks described above. The methods described herein may be embodied as logic instructions on one or more computer-readable medium. When executed on a processor, the logic instructions cause a general purpose computing device to be programmed as a special-purpose machine that implements the described methods. In the following exemplary operations, the components and connections depicted in the figures may be used to implement content-based routing in a computer network.

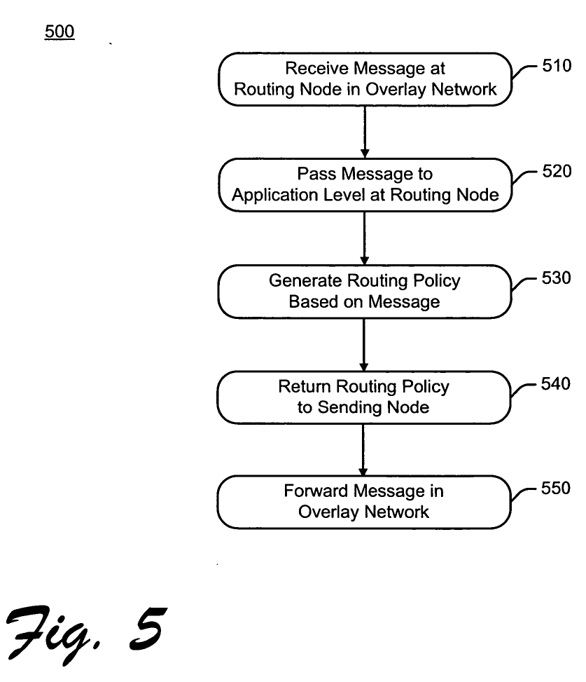

FIG. 5 is a flowchart illustrating exemplary operations 500 that may implement content-based routing. The operations may be implemented, e.g., at a routing node, to return routing policies to a sending node for bypassing one or more intermediary nodes in an overlay network when the sending node issues similar messages.

In operation 510, a routing node receives a message that was issued by a sending node in an overlay network. In operation 520, the message is passed to the application level for processing by the routing node. In operation 530, the routing node generates a routing policy based on the message. In operation 540, the routing node returns the routing policy to the sending node. The message is forwarded in operation 550. The routing node may forward the message to another routing node, or alternatively, to a destination node.

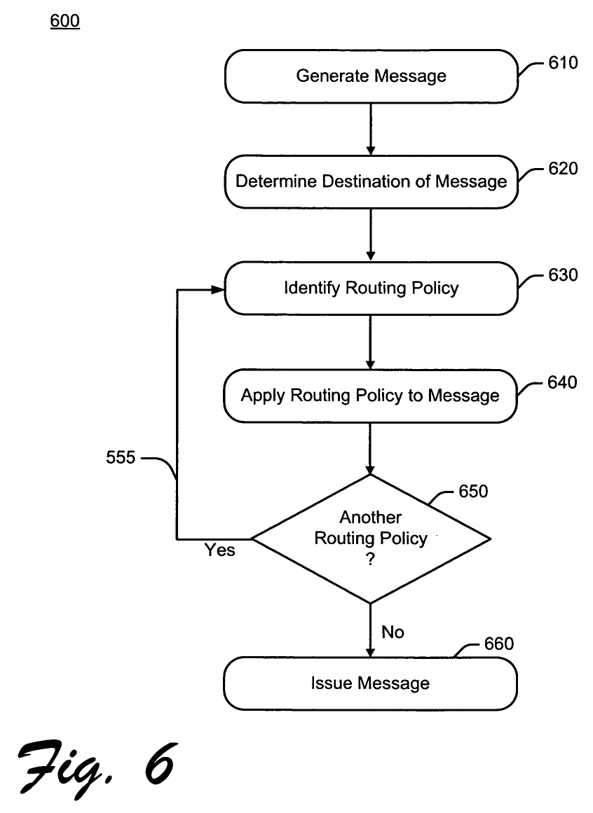

FIG. 6 is another flowchart illustrating exemplary operations 600 that may be implemented for content-based routing. The operations may be implemented, e.g., at a sending node, to apply one or more routing policies to a message. The message may then be issued to a destination node, bypassing one or more intermediary nodes in an overlay network.

In operation 610 a sending node generates a message. The sending node determines an address to send the message in operation 620. The sending node may also identify one or more policies for the message. These policies may include but are not limited to, e.g., data compression, encryption, and security parameters to apply to the message. The sending node may also identify a routing policy in operation 630.

In operation 640, the routing policy is applied to the message. For example, the message may be modified so that it is sent directly to another routing node or to the destination node. In operation 650 the sending node iterates through operations 630-640 until each of the identified routing policies have been applied to the message. In operation 660, the sending node issues the message in the overlay network.

It is noted that the operations shown in FIG. 5 and FIG. 6 are merely illustrative of exemplary implementations of content-based routing and are not intended to limit the scope of the invention to any particular operations or order.

Exemplary Computing Device

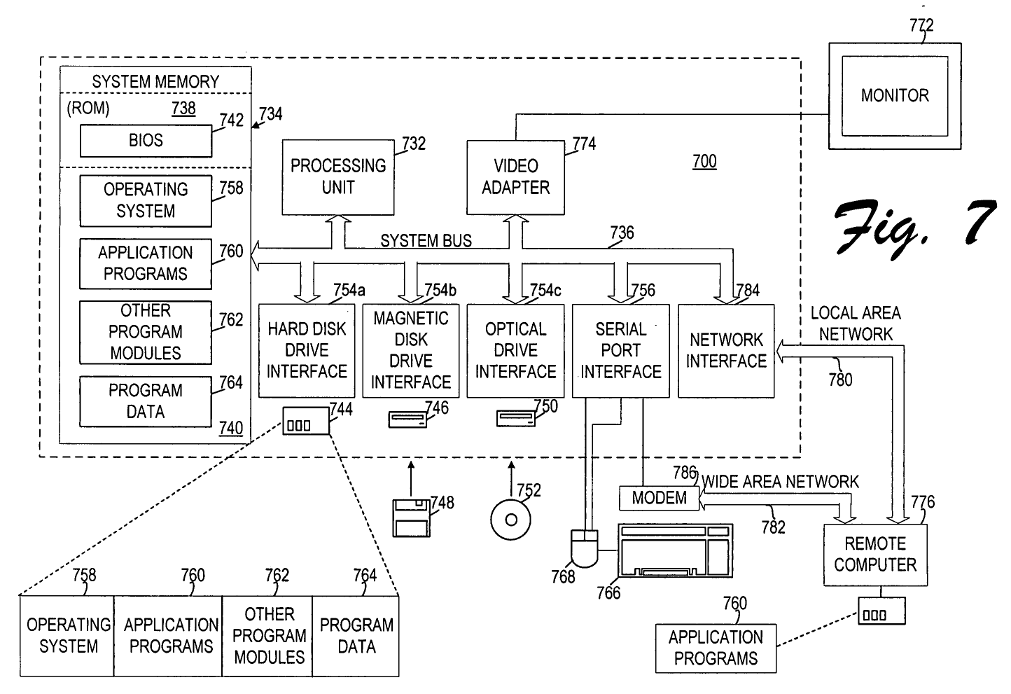

FIG. 7 is a schematic illustration of an exemplary computing device 700 that can be utilized to implement a node in an overlay network. Computing device 700 includes one or more processors or processing units 732, a system memory 734, and a bus 736 that couples various system components including the system memory 734 to processors 732. The bus 736 represents one or more of any of several types of bus structures, including a memory bus or memory controller, a peripheral bus, an accelerated graphics port, and a processor or local bus using any of a variety of bus architectures. The system memory 734 includes read only memory (ROM) 738 and random access memory (RAM) 740. A basic input/output system (BIOS) 742, containing the basic routines that help to transfer information between elements within computing device 700, such as during start-up, is stored in ROM 738.

Computing device 700 further includes a hard disk drive 744 for reading from and writing to a hard disk (not shown), and may include a magnetic disk drive 746 for reading from and writing to a removable magnetic disk 748, and an optical disk drive 750 for reading from or writing to a removable optical disk 752 such as a CD ROM or other optical media. The hard disk drive 744, magnetic disk drive 746, and optical disk drive 750 are connected to the bus 736 by appropriate interfaces 754a, 754b, and 754c. The drives and their associated computer-readable media provide nonvolatile storage of computer-readable instructions, data structures, program modules and other data for computing device 700. Although the exemplary environment described herein employs a hard disk, a removable magnetic disk 748 and a removable optical disk 752, other types of computer-readable media such as magnetic cassettes, flash memory cards, digital video disks, random access memories (RAMs), read only memories (ROMs), and the like, may also be used in the exemplary operating environment.

A number of program modules may be stored on the hard disk 744, magnetic disk 748, optical disk 752, ROM 738, or RAM 740, including an operating system 758, one or more application programs 760, other program modules 762, and program data 764. A user may enter commands and information into computing device 700 through input devices such as a keyboard 766 and a pointing device 768. Other input devices (not shown) may include a microphone, joystick, game pad, satellite dish, scanner, or the like. These and other input devices are connected to the processing unit 732 through an interface 756 that is coupled to the bus 736. A monitor 772 or other type of display device is also connected to the bus 736 via an interface, such as a video adapter 774.

Generally, the data processors of computing device 700 are programmed by means of instructions stored at different times in the various computer-readable storage media of the computer. Programs and operating systems may be distributed, for example, on floppy disks, CD-ROMs, or electronically, and are installed or loaded into the secondary memory of a computer. At execution, the programs are loaded at least partially into the computer's primary electronic memory.

Computing device 700 may operate in a networked environment using logical connections to one or more remote computers, such as a remote computer 776. The remote computer 776 may be a personal computer, a server, a router, a network PC, a peer device or other common network node, and typically includes many or all of the elements described above relative to computing device 700. The logical connections depicted in FIG. 7 include a LAN 780 and a WAN 782.

When used in a LAN networking environment, computing device 700 is connected to the local network 780 through a network interface or adapter 784. When used in a WAN networking environment, computing device 700 typically includes a modem 786 or other means for establishing communications over the wide area network 782, such as the Internet. The modem 786, which may be internal or external, is connected to the bus 736 via a serial port interface 756. In a networked environment, program modules depicted relative to the computing device 700, or portions thereof, may be stored in the remote memory storage device. It will be appreciated that the network connections shown are exemplary and other means of establishing a communications link between the computers may be used.

Nodes may include adapter hardware and software to enable a connection to the communication network. The connection to communication network may be through an optical coupling or more conventional conductive cabling depending on the bandwidth requirements. An adapter may be implemented as a plug-in card on computing device 700. Nodes may implement any number of adapters to provide as many connections to communication network as the hardware and software support.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method comprising:
receiving a message at a routing node in an overlay network; and
generating a routing policy for another node based at least in part on content of the message.

2. The method of claim 1, further comprising modifying the address of the message, and generating the routing policy based the modified address.

3. The method of claim 1, further comprising passing the message to the application level at the routing node to process the message.

4. The method of claim 1, wherein generating the routing policy is at an application level in the routing node.

5. The method of claim 1, further comprising returning the routing policy to a sending node.

6. The method of claim 1, further comprising forwarding the message to another node in the overlay network.

7. A method comprising:
identifying at least one routing policy for a message based on content of the message; and
changing an address in the message to bypass at least one node in an overlay network based on the at least one routing policy.

8. The method of claim 7, further comprising issuing the message directly to a destination node in the overlay network.

9. The method of claim 7, further comprising iteratively applying a plurality of routing policies to the message, each of the plurality of routing policies modifying the address in the message.

10. The method of claim 7, further comprising receiving the at least one routing policy at a sending node in the overlay network.

11. The method of claim 7, further comprising receiving a plurality of routing policies at a sending node from a plurality of routing nodes in the overlay network.

12. The method of claim 7, wherein identifying at least one routing policy is based at least in part on the address of the message.

13. The method of claim 7, further comprising applying a transport policy to the message after changing the address in the message.

14. The method of claim 7, further comprising applying a transport policy to the message only after applying each identified routing policy to the message.

15. A system comprising:
a routing node receiving a message in an overlay network; and
a message processor at the routing node, the message processor generating a routing policy for another node of the message based at least in part on content of the message.

16. The system of claim 15, further comprising a routing table operatively associated with the routing node, the message processor generating the routing policy based on entries in the routing table.

17. The system of claim 15, wherein the routing node includes a messaging level and an application level, the routing node generating the routing policy at the application level.

18. The system of claim 15, wherein the routing node includes a messaging level and an application level, the routing node returning the routing policy to a sending node at the messaging level.

19. The system of claim 15, wherein the routing node includes a messaging level and an application level, the routing node forwarding the message to another node in the overlay network at the messaging level.

20. A system comprising:
at least one routing policy for a message; and
a messaging module changing an address in the message at the sending node to bypass at least one node in an overlay network based on the at least one routing policy.

21. The system of claim 20, wherein the messaging module changes the address for the message so that the message is issued directly to a destination node in the overlay network.

22. The system of claim 20, further comprising a policy manager to identify the at least one routing policy to the messaging module based at least in part on content of the message.

23. The system of claim 20, wherein the at least one routing policy is generated by at least one routing node in the overlay network.

24. The system of claim 20, further comprising a transport policy identifying a transport protocol for the message based on the address in the message.

25. A computer program product encoding a computer program for executing on a computer system a computer process, the computer process comprising:
receiving a message at a routing node in an overlay network; and
generating a routing policy for another node of the message based at least in part on content of the message.

26. The computer program product of claim 25 wherein the computer process further comprises identifying an address to route the message, and generating the routing policy based the address.

27. The computer program product of claim 25 wherein the computer process further comprises passing the message to the application level at the routing node to process the message.

28. The computer program product of claim 25 wherein the computer process further comprises generating the routing policy at an application level in the routing node.

29. The computer program product of claim 25 wherein the computer process further comprises returning the routing policy to a sending node.

30. The computer program product of claim 25 wherein the computer process further comprises forwarding the message to another node in the overlay network.

31. A computer program product encoding a computer program for executing on a computer system a computer process, the computer process comprising:
identifying at least one routing policy for a message based on content of the message; and
changing an address in the message to bypass at least one node in an overlay network based on the at least one routing policy.

32. The computer program product of claim 31 wherein the computer process further comprises issuing the message in the overlay network directly to a destination node.

33. The computer program product of claim 31 wherein the computer process further comprises iteratively applying a plurality of routing policies to the message, each of the plurality of routing policies changing the address in the message.

34. The computer program product of claim 31 wherein the computer process further comprises receiving the at least one routing policy at a sending node in the overlay network.

35. The computer program product of claim 31 wherein the computer process further comprises receiving a plurality of routing policies at a sending node from a plurality of routing nodes in the overlay network.

36. The computer program product of claim 31 wherein the computer process further comprises identifying at least one routing policy based at least in part on the address in the message.

37. The computer program product of claim 31 wherein the computer process further comprises applying a transport policy to the message after changing the address in the message.

38. The computer program product of claim 31 wherein the computer process further comprises applying a transport policy to the message only after applying each identified routing policy to the message.
